(19) United States
(12) Patent Application Publication
(10) Pub. No.: US 2015/0066326 A1
(43) Pub. Date: Mar. 5, 2015

(54) Brake System, Brake Apparatus, and Method for Controlling Brake System

(71) Applicant: Hitachi Automotive Systems, Ltd., Hitachinaka-shi (JP)

(72) Inventor: Hiroshi FURUYAMA, Obihiro-shi (JP)

(21) Appl. No.: 14/477,218

(22) Filed: Sep. 4, 2014

(30) Foreign Application Priority Data
Sep. 5, 2013 (JP) 2013-184371

(51) Int. Cl. B60T 13/66; B60L 7/18; B60T 13/68

(52) U.S. Cl. CPC B60T 13/66; B60T 13/686; B60L 7/18
USPC 701/70; 303/10

(57) ABSTRACT

A brake system includes an upstream brake fluid pressure generating device automatically generating a fluid pressure in a master cylinder to control a wheel cylinder fluid pressure in a wheel cylinder provided for a wheel, a downstream brake fluid pressure generating device driving a pump and a control valve to variably control the wheel cylinder fluid pressure with a brake fluid sucked in from the master cylinder by the pump, a brake operating part provided separately from a brake pedal so as to be operated by a driver to apply braking force to the wheel, and a wheel cylinder fluid pressure cooperative control unit controlling the wheel cylinder fluid pressure by activating at least one of the upstream brake fluid pressure generating device and the downstream brake fluid pressure generating device in response to an operation of the brake operating part.

### BACKGROUND OF THE INVENTION

The present invention relates to a brake system and brake apparatus performing brake control by controlling the fluid pressure in a wheel cylinder. The present invention also relates to a method of controlling the brake system.

Japanese Patent Application Publication No. 2000-203410 (hereinafter, referred to as Patent Document 1) discloses a parking brake system having a fluid-pressure-operated brake performing brake control by controlling the fluid pressure in a wheel cylinder with a fluid pressure generated by a pump, and a parking brake performing brake control with actuating force of a parking brake lever. The fluid-pressure-operated brake and the parking brake are integrally formed with each other. When actuation of the parking brake lever is detected, a fluid pressure generated by the pump is supplied to the wheel cylinder to realize a parking brake function.

Patent Document 1: JP 2000-203410

With the technique disclosed in the above-described Patent Document 1, when the parking brake lever is operated, the pump is driven to generate a wheel cylinder pressure; therefore, it is required to reduce operating noise of the pump and also operating noise from various actuators. Achieving noise reduction of the pump and other various actuators such as a motor and an electromagnetic valve, however, leads to an increase in cost.

The present invention has been made in view of the above-described problems.

Accordingly, an object of the present invention is to provide a brake system capable of attaining noise reduction at low cost.

### SUMMARY OF THE INVENTION

To attain the above-described object, the present invention provides a brake system including an upstream brake fluid pressure generating device automatically generating a fluid pressure in a master cylinder to control a wheel cylinder fluid pressure in a wheel cylinder provided for a wheel, a downstream brake fluid pressure generating device driving a pump and a control valve to variably control the wheel cylinder fluid pressure with a brake fluid sucked in from the master cylinder by the pump, a brake operating part provided separately from a brake pedal so as to be operated by a driver to apply braking force to the wheel, and a wheel cylinder fluid pressure cooperative control unit controlling the wheel cylinder fluid pressure by activating at least one of the upstream brake fluid pressure generating device and the downstream brake fluid pressure generating device in response to an operation of the brake operating part.

### BRIEF DESCRIPTION OF THE DRAWINGS

FIG. 1 is a block diagram showing an overall system configuration of a brake apparatus according to a first embodiment of the present invention.

FIG. 2 is a block diagram showing the control system of the brake apparatus according to the first embodiment.

FIG. 3 is a diagram showing a fluid pressure circuit in a fluid pressure control unit in the first embodiment.

FIG. 4 is a flowchart showing parking brake control processing in the first embodiment.

FIG. 5 is a time chart showing parking brake control processing in the first embodiment.

FIG. 6 is a map showing a braking force distribution characteristic in the first embodiment.

FIG. 7 is a characteristic diagram showing the characteristics of the braking force distribution value in the first embodiment.

FIG. 8 is a map showing an electric parking brake operating characteristic in the first embodiment.

### DETAILED DESCRIPTION OF THE PREFERRED EMBODIMENTS

### First Embodiment

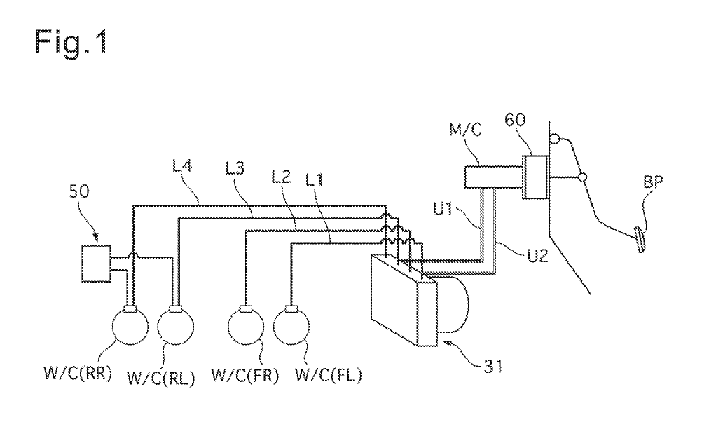

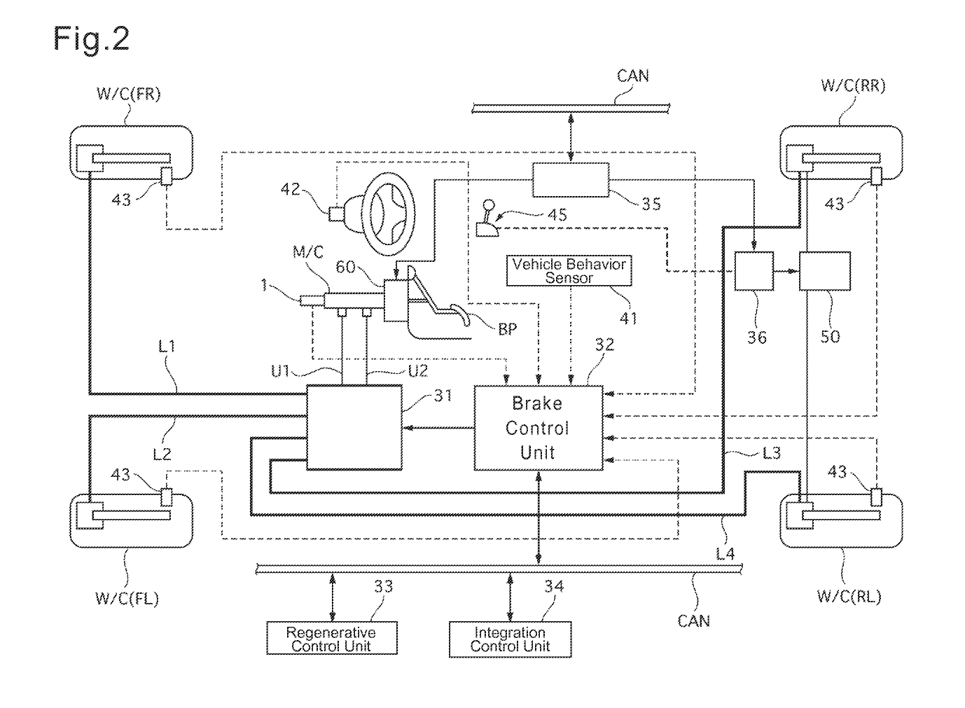

FIG. 1 is a block diagram showing an overall system configuration of a brake apparatus according to a first embodiment of the present invention. FIG. 2 is a block diagram showing the control system of the brake apparatus according to the first embodiment. A vehicle in the first embodiment is a hybrid vehicle or electric car having a motor generator as a drive source. An integration control unit 34 executes control to output driving force in accordance with an operation of an accelerator pedal by a driver, and so forth. A regenerative control unit 33 performs, when a brake pedal BP is operated, cooperative control of fluid pressure braking force and electric regenerative braking force, and outputs a control command to a brake control unit 32 and to the integration control unit 34 to attain desired deceleration. It should be noted that the brake control unit 32, the regenerative control unit 33, and the integration control unit 34 are connected to a CAN (Controller Area Network) communication line CAN to transmit and receive sensor information and control signals among each other, thereby controlling the running condition of the vehicle.

Each wheel (FR, FL, RR, and RL) has a wheel cylinder W/C generating fluid pressure braking force, and a wheel speed sensor 43 detecting the wheel speed of each wheel. The brake apparatus further has a steering angle sensor 42 calculating a steering angle through which a steering wheel has been turned by the driver, a vehicle behavior sensor 41 detecting vehicle behaviors (lateral acceleration, longitudinal acceleration, yaw rate, etc.), and a master cylinder pressure sensor 1 detecting a master cylinder pressure representing a driver's brake pedal operation state (brake pedal operating quantity). It should be noted that the driver's brake pedal operating quantity is not limited to the master cylinder pressure, and that a brake pedal stroke or brake pedal pressure (i.e. depressing force applied to the brake pedal BP) may be detected as the driver's brake pedal operating quantity. Further, an ON signal of a brake light switch may be used in place of the longitudinal acceleration detection signal. The brake control unit 32 calculates a control signal based on each detected sensor signal in addition to control signals received through the CAN communication line CAN and outputs a control command signal to an ESC (Electronic Stability Control) 31. It should be noted that the interior structure of the ESC 31 will be explained later.

The brake pedal BP is provided with a service brake control device (hereinafter referred to as an “E-ACT”) 60 as an upstream brake fluid pressure generating device capable of electrically controlling the stroke quantity corresponding to the brake pedal pressure, and an E-ACT controller 35 controlling the operating state of the E-ACT 60. The E-ACT 60 is connected to a tandem master cylinder M/C and has an electric motor capable of applying axial assist force to the pistons in the master cylinder M/C. With this arrangement, when the electric motor is driven, the force for moving the pistons in the master cylinder M/C is controlled, and thus the master cylinder pressure can be controlled. The E-ACT controller 35 performs transmission and reception of information with other controllers through the CAN communication line CAN. The interior of the master cylinder M/C is divided into a primary cylinder chamber and a secondary cylinder chamber (both not shown). The primary cylinder chamber is connected to P-line piping U1, and the secondary cylinder chamber is connected to S-line piping U2. The P-line piping U1 and the S-line piping U2 are connected to an anti-skid brake system (hereinafter referred to as an “ESC”) 31 as a downstream brake fluid pressure generating device. The ESC 31 is connected to the wheel cylinders W/C of the four wheels through piping L1, L2, L3 and L4.

The wheel cylinders W/C (RR) and W/C (RL) for the rear wheels are provided with an electric parking brake actuator (hereinafter referred to as an “E-PKB”) 50 capable of generating braking force by an action other than that of fluid pressure supplied through the piping L3 and L4 as an ordinary braking force generating source. The wheel cylinders W/C (RR) and W/C (RL) are further provided with an E-PKB controller 36. The structure of the E-PKB 50 is not particularly limited; the E-PKB 50 may be configured to supply a fluid pressure to the wheel cylinders W/C or may be configured to press a brake pad against a brake rotor by an electric motor, for example. In addition, a parking brake switch 45 operable by the driver is provided near the driver's seat. The E-PKB controller 36 controls the operating state of the E-PKB 50 based on a switch operation signal transmitted from the parking brake switch 45 and a control signal transmitted from the E-ACT controller 35.

### [Overall Structure of Brake Control System]

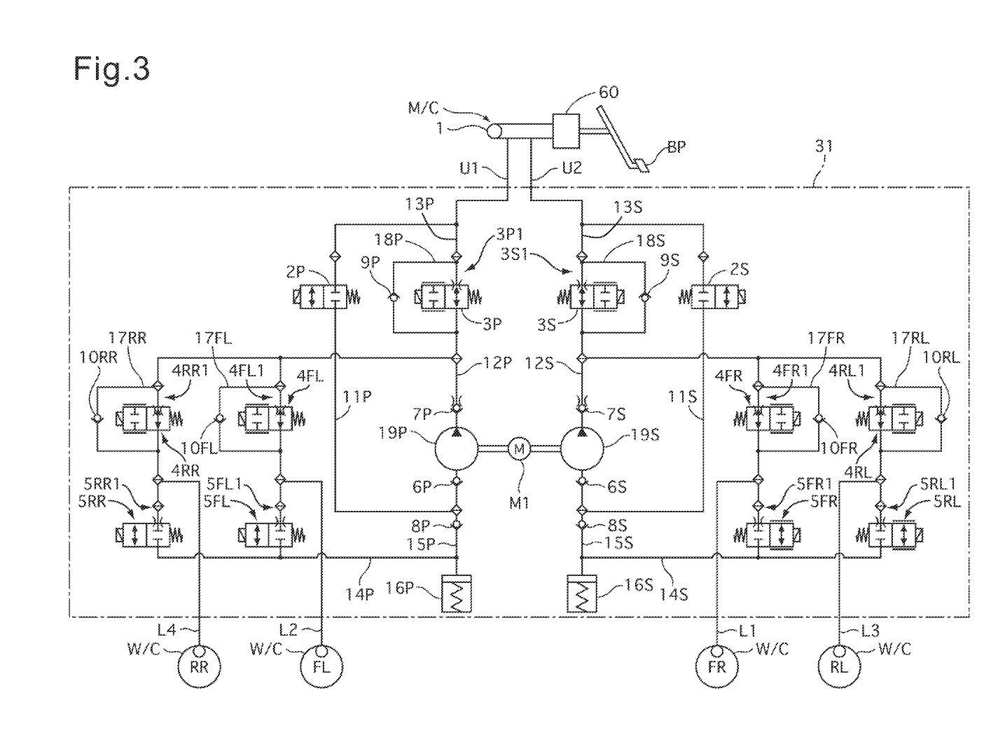

FIG. 3 is a diagram showing a fluid pressure circuit in a fluid pressure control unit in the first embodiment. To the P-line of the ESC 31 are connected the wheel cylinder W/C (FL) of the front left wheel and the wheel cylinder W/C (RR) of the rear right wheel. To the S line of the ESC 31 are connected the wheel cylinder W/C (FR) of the front right wheel and the wheel cylinder W/C (RL) of the rear left wheel.

The P line and the S line are provided with gear pumps 19P and 19S (hereinafter referred to as “gear pumps 19”), respectively. The gear pumps 19 are driven by a motor M1. The master cylinder M/C and the suction sides of the gear pumps 19 are connected by pipelines 11P and 11S (hereinafter referred to as “pipelines 11”) which are connected to the piping U1 and U2, respectively. The pipelines 11 are provided with gate-in valves 2P and 2S (hereinafter referred to as “gate-in valves 2”), which are normally-closed electromagnetic valves, respectively. In addition, check valves 6P and 6S (hereinafter referred to as “check valves 6”) are provided on the pipelines 11 between the gate-in valves 2 and the gear pumps 19, respectively. The check valves 6 allow flow of brake fluid in a direction from the gate-in valves 2 toward the gear pumps 19 but prevent flow of brake fluid in the opposite direction.

The discharge sides of the gear pumps 19 and the wheel cylinders W/C are connected by pipelines 12P and 12S (hereinafter referred to as “pipelines 12”), respectively. The pipelines 12 are provided with solenoid-in valves 4FL, 4RR. 4FR and 4RL (hereinafter referred to as “solenoid-in valves 4”), which are normally-open proportional control electromagnetic valves provided in association with the wheel cylinders W/C, respectively. Check valves 7P and 7S (hereinafter referred to as “check valves 7”) are provided on the pipelines 12 between the solenoid-in valves 4 and the gear pumps 19, respectively. The check valves 7 allow flow of brake fluid in a direction from the gear pumps 19 toward the solenoid-in valves 4 but prevent flow of brake fluid in the opposite direction.

Further, the pipelines 12 are provided with pipelines 17FL, 17RR, 17FR and 17RL (hereinafter referred to as “pipelines 17”) which bypass the solenoid-in valves 4, respectively. The pipelines 17 are provided with check valves 10FL, 10RR, 10FR and 10RL (hereinafter referred to as “check valves 10”), respectively. The check valves 10 allow flow of brake fluid in a direction from the wheel cylinders W/C toward the gear pumps 19 but prevent flow of brake fluid in the opposite direction.

The master cylinder M/C and the pipelines 12 are connected by pipelines 13P and 13S (hereinafter referred to as “pipelines 13”). The pipelines 12 and the pipelines 13 join each other at respective points between the gear pumps 19 and the solenoid-in valves 4. The pipelines 13 are provided with gate-out valves 3P and 3S (hereinafter referred to as “gate-out valves 3”), respectively, which are normally-open proportional control electromagnetic valves.

Further, the pipelines 13 are provided with pipelines 18P and 18S (hereinafter referred to as “pipelines 18”) which bypass the gate-out valves 3, respectively. The pipelines 18 are provided with check valves 9P and 9S (hereinafter referred to as “check valves 9”), respectively. The check valves 9 allow flow of brake fluid in a direction from the master cylinder M/C toward the wheel cylinders W/C but prevent flow of brake fluid in the opposite direction.

The suction sides of the gear pumps 19 are provided with reservoirs 16P and 16S (hereinafter referred to as “reservoirs 16”), respectively. The reservoirs 16 and the gear pumps 19 are connected by pipelines 15P and 15S (hereinafter referred to as “pipelines 15”), respectively. Check valves 8P and 8S (hereinafter referred to as “check valves 8”) are provided between the reservoirs 16 and the gear pumps 19, respectively. The check valves 8 allow flow of brake fluid in a direction from the reservoirs 16 toward the gear pumps 19 but prevent flow of brake fluid in the opposite direction. The wheel cylinders W/C and the pipelines 15 are connected by pipelines 14P and 14S (hereinafter referred to as “pipelines 14”), respectively. The pipelines 15 and the pipelines 14 join each other at respective points between the check valves 8 and the reservoirs 16. The pipelines 14 are provided with solenoid-out valves 5FL, 5RR, 5FR and 5RL (hereinafter referred to as “solenoid-out valves 5”), respectively, which are normally-closed electromagnetic valves.

The solenoid valves (gate-in valves 2, gate-out valves 3, solenoid-in valves 4, and solenoid-out valves 5) are controlled by the brake control unit 32. The brake control unit 32 performs the following control processes based on control signals from other control units, signals input to the brake control unit 32 from various sensors, and so forth: brake assist control to provide additional braking force; anti-skid brake control (ABS) to avoid locking of the wheels; and vehicle behavior stabilization control (ESC) to stabilize behaviors of the vehicle. Further, the brake control unit 32 performs calculation for controlling tire slip and vehicle behavior by using vehicle information for inter-vehicle distance control and obstacle avoidance control, which is sent from other controllers, to obtain braking force (for all the wheels) required for the vehicle, calculates a target value of braking force required for each wheel, and outputs a control command.

### [Parking Brake Control Processing]

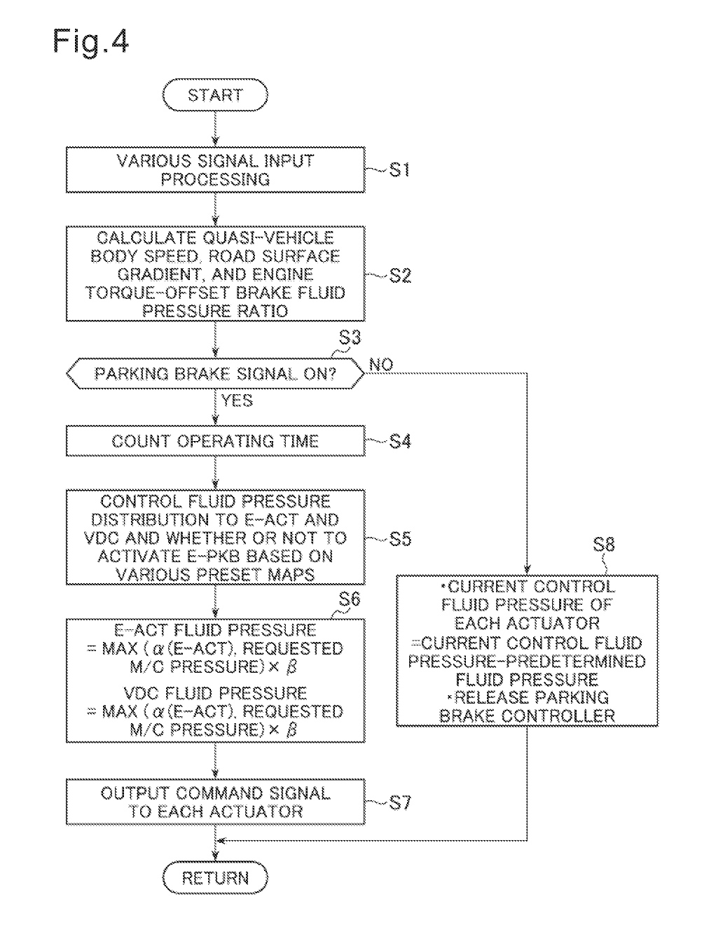

FIG. 4 is a flowchart showing parking brake control processing in the first embodiment. The parking brake control is executed repeatedly every predetermined control cycle in the brake control unit 32 to calculate a command value, and a control signal is output to the ESC 31 based on the calculated command value. At step S1, the brake control unit 32 executes sensor signal input processing. In this processing, the raw values of various sensor signals are read in association with the read cycle of each controller and so forth, as signals unaffected by aliasing noise after passing through a hardware low-pass filter. Then, the brake control unit 32 executes software low-pass filter processing to remove vehicle vibration and electric noise superimposed on the sensor signals. The low-pass filter frequency characteristic is set to such a frequency that a change in pressure and a change in behavior can be satisfactorily detected even when the driver makes a sharp maneuver. Signals input to the brake control unit 32 include a parking brake switch operation signal, a wheel speed signal, a lateral acceleration signal, a longitudinal acceleration signal, a master cylinder pressure signal, and an engine-generated torque signal.

At step S2, the brake control unit 32 calculates a quasi-vehicle body speed based on the wheel speed signals representing the wheel speeds of the four wheels, of the sensor signals subjected to the input processing, and also calculates a road surface gradient based on the deviation between the gradient of change of the quasi-vehicle body speed and the longitudinal acceleration signal. Further, the brake control unit 32 calculates an engine torque-offset brake fluid pressure ratio, which is a ratio at which the brake fluid pressure is offset by the engine-generated torque. At step S3, it is judged whether or not the parking brake switch operation signal is ON. If YES, it is judged that the driver is making a request to stop the vehicle, and the process proceeds to step S4; otherwise, the process proceeds to step S8. At step S8, a predetermined fluid pressure value is subtracted from the present control fluid pressure of each actuator, and the parking brake control is terminated. It should be noted that, when the parking brake switch 45 is switched over from ON to OFF, the target braking force command value is gradually reduced so that the wheel cylinder pressure becomes zero after a predetermined time has elapsed. At step S4, the brake control unit 32 counts the time during which the parking brake switch operation signal is ON, i.e. the parking brake switch operating time.

At step S5, on the basis of preset maps, fluid pressure distribution to the E-ACT 60 and fluid pressure distribution to the ESC (VDC) 31 are set, and whether or not to activate the E-PKB 50 is controlled, and a required fluid pressure value for each actuator is calculated to obtain the set fluid pressure distribution. At step S6, a comparison is made between the required fluid pressure value calculated at step S5 and the requested master cylinder pressure currently generated in response to the driver's operation, and one of the two pressure values which is larger than the other is selected. Further, the selected value is multiplied by the engine torque-offset brake fluid pressure ratio P to obtain a control fluid pressure to be generated by the E-ACT 60 and a control fluid pressure to be generated by the ESC 31. At step S7, command signals each for actuating each actuator to obtain the control fluid pressure set at step S6 are outputted to the actuators.

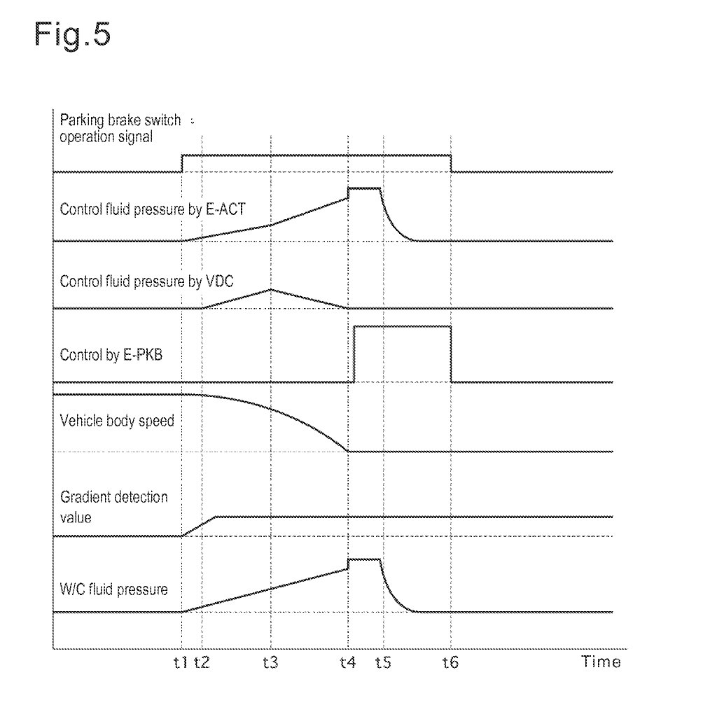

FIG. 5 is a time chart showing parking brake control processing in the first embodiment. When the driver starts to operate the parking brake switch 45 during running of the vehicle at time t1, distribution of braking to be performed by each brake device is made based on the time elapsed from the start of the operation of the parking brake switch 45. Immediately after the start of the operation, the required braking force is ensured by the E-ACT 60. When the braking force reaches a set value to be a braking force distribution value GO at t2, the ratio of distribution to the ESC 31 is gradually increased.

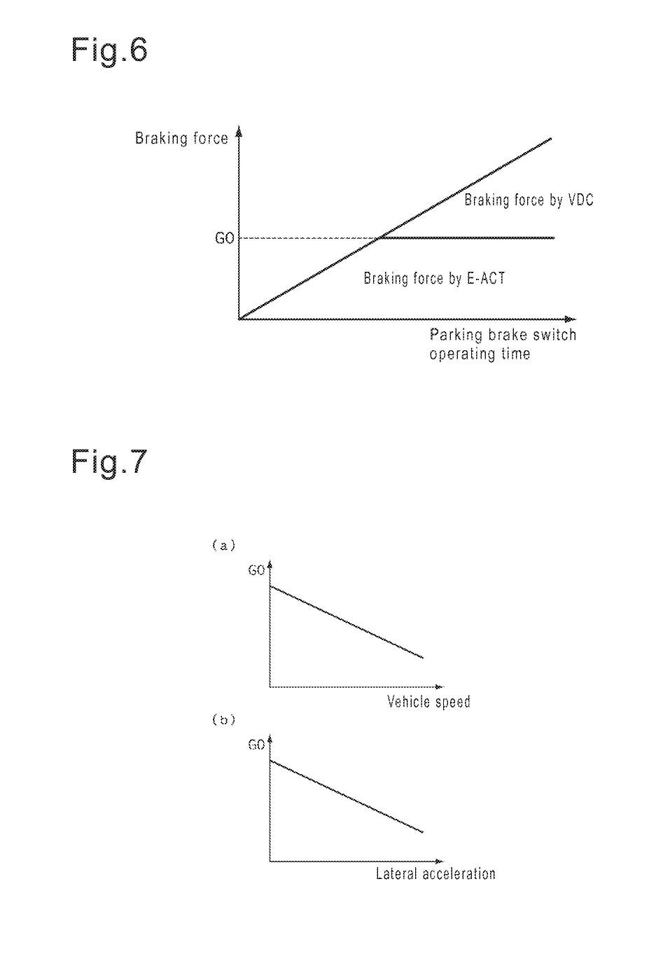

FIG. 6 is a map showing a braking force distribution characteristic in the first embodiment. FIG. 7 is a characteristic diagram showing the characteristics of the braking force distribution value in the first embodiment. According to the braking force distribution characteristic map shown in FIG. 6, the braking force distribution to the E-ACT 60 and the ESC 31 is set according to the elapse of time during which the parking brake switch 45 is operated. Part (a) of FIG. 7 shows a characteristic in which a smaller braking force distribution value GO is set as the vehicle speed increases. Part (b) of FIG. 7 shows a characteristic in which a smaller braking force distribution value GO is set as the lateral acceleration increases. The braking force distribution value GO, which eventually becomes a braking force distribution standard as set in FIG. 6, assumes a smaller value of the braking force distribution values GO set in parts (a) and (b) of FIG. 7. More specifically, when the vehicle is at a high vehicle speed or is turning at high lateral acceleration, noise is less offensive to the driver. If the parking brake switch 45 is operated in this state, the ratio of distribution to the ESC 31, which is accompanied by noise due to the pump operation, is increased. Thus, the frequency of activation of the E-ACT 60 can be reduced without giving the driver a sense of incongruity with noise.

Further, the brake control unit 32 detects a road surface gradient and calculates an engine torque-offset brake fluid pressure ratio, which is a ratio at which the brake fluid pressure is offset by the engine-generated torque. Further, the brake control unit 32 sets an actually required brake fluid pressure according to the running condition with respect to the requested braking force. In the case of the time chart shown in FIG. 5, because the road surface gradient is detected, the fluid pressure for attaining the requested braking force is set lower than the fluid pressure when the vehicle is running on a flat road surface.

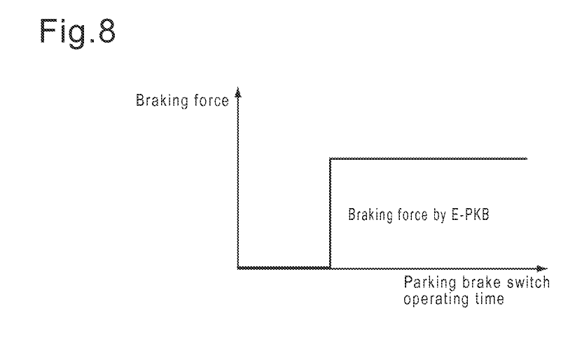

When a reduction in vehicle speed is confirmed at time t3, the braking force distribution value GO set according to the vehicle speed gradually increases, so that the braking force generated by the ESC 31 reduces, and, at the same time, the braking force generated by the E-ACT 60 increases. When the vehicle stops at time t4, the braking force generated by the E-ACT 60 is increased at a stretch to the brake fluid pressure when the vehicle is at a halt, and after a predetermined time has elapsed, the E-PKB 50 is activated. FIG. 8 is a map showing an electric parking brake operating characteristic in the first embodiment. When it is judged that the vehicle has stopped, the E-PKB 50 is activated to lock the wheels after a predetermined time has elapsed from the time when the vehicle is judged to be stopped. When it is confirmed at time t5 that the wheels have been locked by the activation of the E-PKB 50, the fluid pressure generated by the E-ACT 60 is released. Consequently, the wheel cylinder pressure gradually lowers and eventually reaches zero. When the operation of the parking brake switch 45 by the driver is terminated at time t6, the wheel cylinder pressure is gradually reduced so as to reach zero after a predetermined time has elapsed, and the control by the E-PKB 50 is terminated, thus allowing the vehicle to be restarted.

As has been stated above, the first embodiment provides advantages as listed below.

(1) A brake system includes: a master cylinder M/C generating a fluid pressure in response to an operation of a brake pedal BP by a driver; an E-ACT 60 (upstream brake fluid pressure generating device) automatically generating a fluid pressure in the master cylinder M/C to control a wheel cylinder fluid pressure in a wheel cylinder provided for a wheel; an ESC 31 (downstream brake fluid pressure generating device) driving a gear pump 19 (pump) and a control valve to variably control the wheel cylinder fluid pressure with a brake fluid sucked in from the master cylinder M/C by the gear pump 19; a parking brake switch 45 (brake operating part) provided separately from the brake pedal BP so as to be operated by the driver to apply braking force to the wheel; and an E-ACT controller 35 (wheel cylinder fluid pressure cooperative control unit) controlling the wheel cylinder fluid pressure by activating at least one of the E-ACT 60 and the ESC 31 in response to an operation of the parking brake switch 45. Accordingly, it is possible to realize cooperative control by a plurality of actuators capable of generating braking force based on an operation of the parking brake switch 45 and hence possible to reduce the frequency of activation of each fluid pressure generating device. It should be noted that the activation frequency can also be reduced by an arrangement wherein an E-PKB 50 is assumed to be or used as the downstream brake fluid pressure generating device and activated after the vehicle has stopped.
(2) The brake system as set forth in the above (1) includes: a step S1 (brake operating part operating quantity calculating section (displacement, angle)) of calculating an operating quantity of the parking brake switch 45; a step S2 (target braking force command value calculating section) of calculating a command value of target braking force in accordance with the calculated brake operating part operating quantity; and a step S5 (upstream and downstream target braking force command value calculating section) of distributing the calculated command value of target braking force into a command value of braking force (upstream target braking force command value) for activating the E-ACT 60 to generate the braking force and a command value of braking force (downstream target braking force command value) for activating the ESC 31 to generate the braking force, which is larger than the command value of braking force to be generated by the E-ACT 60; wherein the E-ACT controller 35 selectively or simultaneously activates at least one of the E-ACT 60 and the ESC 31 in accordance with the calculated operating quantity of the parking brake switch 45 and the magnitude of the command value of braking force to be generated by the E-ACT 60. Accordingly, it is possible to reduce the frequency of activation of the E-ACT 60 and also possible to reduce the activation frequency of the ESC 31. Thus, operating noise can be reduced. It should be noted that, in the first embodiment, the operating time of the parking brake switch 45 is used as the brake operating part operating quantity. However, the brake operating part operating quantity is not particularly limited to the operating time of the parking brake switch 45. For example, the brake operating part operating quantity may be determined by the operating quantity (actuating quantity) or operating position (actuating angle) of the parking brake switch 45.
(3) The brake system as set forth in the above (1) includes a step S2 (vehicle body speed calculating section) of calculating a quasi-vehicle body speed which is a speed of a vehicle body, wherein the E-ACT controller 35 selects at least one of the E-ACT 60 and the ESC 31 to be activated in accordance with the calculated vehicle body speed. In other words, when the vehicle body speed is in a low speed region in which quietness is required, the E-ACT 60 is activated to generate a fluid pressure quietly, whereas, when the vehicle body speed is in a high speed region in which operating noise is not offensive to the driver, the pump of the ESC 31 is activated to generate a fluid pressure, thereby achieving a reduction in operating noise and, at the same time, allowing a reduction in the frequency of activation of each actuator.
(4) The brake system as set forth in the above (3) includes a step S5 (upstream and downstream target braking force command value correcting section) of correcting the command values of braking force (upstream and downstream target braking force command values) to be generated by the E-ACT 60 and the ESC 31 calculated at the step S2 (target braking force command value calculating section), wherein, when the distribution of the braking force command value calculated in accordance with the operating time (or operating quantity) of the parking brake switch 45 (brake operating part) is changed in accordance with the vehicle body speed, the distribution of the braking force command value to each of the brake fluid pressure generating devices is proportionally changed when the vehicle body speed is between a first preset vehicle body speed and a second preset vehicle body speed other than the first preset vehicle body speed. Accordingly, when the distribution of brake fluid pressure to be generated by each brake device is switched over, it is possible to suppress the driver from feeling an incongruous pedal sensation, an incongruous braking sensation and a sense of incongruity due to a sudden change in operating noise
(5) The brake system as set forth in the above (2) includes: a step S4 (brake operating part operating quantity calculating section) of calculating an operating time (operating quantity) of the parking brake switch 45; a step S5 (target braking force command value calculating section) of calculating a command value of target braking force in accordance with the calculated operating time (brake operating part operating quantity); a step S5 (upstream and downstream target braking force command value calculating section) of distributing the calculated command value of target braking force into a command value of braking force (upstream target braking force command value) for activating the E-ACT 60 (upstream brake fluid pressure generating device) to generate the braking force and a command value of braking force (downstream target braking force command value) for activating the ESC 31 (downstream brake fluid pressure generating device) to generate the braking force, which is larger than the upstream target braking force command value; and a step S1 (lateral acceleration calculating section) of calculating lateral acceleration acting on the vehicle; wherein the upper limit value of the calculated command value of braking force (upstream target braking force command value) to be generated by the E-ACT 60 is changed in accordance with the magnitude of the calculated lateral acceleration. In other words, when the lateral acceleration is in a low lateral acceleration region in which quietness is required, the E-ACT 60 is activated to generate a fluid pressure quietly, whereas, when the lateral acceleration is in a high lateral acceleration region in which operating noise is not offensive to the driver, the pump of the ESC 31 is activated to generate a fluid pressure, thereby achieving a reduction in operating noise and, at the same time, allowing a reduction in the frequency of activation of each actuator.
(6) In the brake system as set forth in the above (5), the upper limit value of the calculated upstream target braking force command value is changed in accordance with the magnitude of the calculated lateral acceleration, and the distribution of the braking force command value to each of the brake fluid pressure generating devices is proportionally changed when the calculated lateral acceleration is between a first preset value of lateral acceleration and a second preset value of lateral acceleration other than the first preset value of lateral acceleration. Accordingly, when the distribution of brake fluid pressure to be generated by each brake device is switched over, it is possible to suppress the driver from feeling an incongruous pedal sensation, an incongruous braking sensation and a sense of incongruity due to a sudden change in operating noise.
(7) The brake system as set forth in the above (5) includes a step S4 (brake operating part operating quantity calculating section) of calculating an operating time (operating quantity) of the parking brake switch 45, and a step S5 (target braking force command value calculating section) of calculating a command value of target braking force in accordance with the calculated operating time (brake operating part operating quantity), wherein the parking brake switch 45 is switchable by the driver, and when the parking brake switch 45 is turned from ON to OFF, the target braking force command value is gradually reduced so that the fluid pressure reaches zero after a predetermined time has elapsed. Accordingly, it is possible to suppress a sudden change in vehicle behavior due to switching of the brake devices.

Although some embodiments have been described above, the present invention is not limited to the foregoing embodiments; other structures are also included in the present invention. Other embodiments of the present invention and advantages thereof will be listed below.

(8) The brake system as set forth in the above (5) may be arranged as follows. A parking lever actuatable by a driver's pulling operation is used as a brake operating part in place of the parking brake switch 45, and the target braking force command value calculating section reduces the command value of target braking force in accordance with the operating quantity of the parking lever. In this case, it is possible to realize a change in deceleration according to the driver's request.
(9) The brake system as set forth in the above (2) may be arranged as follows. The brake system includes an accelerator pedal operation state calculating section calculating a driver's accelerator pedal operation state, and when an accelerator pedal depressing state is calculated by the accelerator pedal operation state calculating section, the target braking force command value is increased by adding thereto braking force for canceling torque estimated to be generated by depression of the accelerator pedal. In this case, even if the driver mistakenly depresses the accelerator pedal while braking the vehicle with the parking brake switch 45, the vehicle can be surely stopped by the actuators, and thus safety can be improved.
(10) The brake system as set forth in the above (1) may be arranged such that a stop light provided on the vehicle is turned on when a braking operation is started with the parking brake switch 45 and the resulting deceleration is not less than a predetermined deceleration value. With this arrangement, the stop light is turned on during braking even when the braking operation is started by the driver with a brake operating part other than the brake pedal, thereby making it possible to ensure safety with respect to vehicles following the vehicle concerned.
(11) The brake system as set forth in the above (1) may include a driving force reduction control section reducing driving force (driving torque) of a drive source mounted on the vehicle when a braking operation is started with the parking brake switch 45. With this arrangement, when a driver's braking intension is recognized, the generation of unnecessary driving force is reduced, thereby allowing a reduction in load on each braking force generating actuator.
(12) In the brake system as set forth in the above (11), the driving force reduction control section desirably reduces the driving force to a level not higher than braking force (braking torque) generated by activating at least one of the E-ACT 60 and the ESC 31. With this arrangement, the vehicle can be surely stopped.
(13) The brake system as set forth in the above (1) may be arranged such that, when a braking operation is started with the parking brake switch 45, the gear ratio of a transmission mounted on the vehicle is switched to the low-speed side. By switching the gear ratio of the transmission to the low-speed side as stated above, engine braking force can be obtained, and thus the durability of the actuators and the brakes can be improved.
(14) The brake system as set forth in the above (1) may include a regenerative brake device, wherein the regenerative brake device is activated when a braking operation is started with the brake operating part. With this arrangement, regenerative braking force can be obtained by activating the regenerative brake device, and thus the durability of the actuators and the brakes can be improved.
(15) A brake apparatus includes: an E-ACT 60 (upstream brake fluid pressure generating device) automatically generating a fluid pressure in a master cylinder M/C that generates a fluid pressure in response to an operation of a brake pedal BP by a driver to control a wheel cylinder fluid pressure in a wheel cylinder provided for a wheel; an ESC 31 (downstream brake fluid pressure generating device) driving a gear pump 19 (pump) and a control valve to variably control the wheel cylinder fluid pressure with a brake fluid sucked in from the master cylinder M/C by the gear pump 19 (pump); a parking brake switch 45 (brake operating part) provided separately from the brake pedal BP so as to be operated by the driver to apply braking force to the wheel; and an E-ACT controller 35 (wheel cylinder fluid pressure cooperative control unit) controlling the wheel cylinder fluid pressure by activating at least one of the E-ACT 60 and the ESC 31 in response to an operation of the parking brake switch 45. Accordingly, it is possible to realize cooperative control by a plurality of actuators capable of generating braking force based on an operation of the parking brake switch 45 and hence possible to reduce the frequency of activation of each fluid pressure generating device. It should be noted that the activation frequency can also be reduced by an arrangement wherein an E-PKB 50 is assumed to be or used as the downstream brake fluid pressure generating device and activated after the vehicle has stopped.
(16) The brake apparatus as set forth in the above (15) may be arranged as follows. The E-ACT 60 has a motor (upstream actuator) driving the master cylinder M/C to cause an axial movement of a piston, and the ESC 31 has a plunger pump. In this arrangement, the E-ACT controller 35 may activate the E-ACT 60. Although the first embodiment shows an example having a gear pump, a plunger pump may be used in place of the gear pump. In this case, the plunger pump can output a high pressure at low cost but involves a problem in terms of quietness. However, the frequency of activation of the pump can be reduced by cooperative control. Therefore, it is possible to provide a brake apparatus superior in quietness at low cost.
(17) In the brake apparatus as set forth in the above (16), the actuator of the E-ACT 60 may be an electric motor. With this arrangement, the master cylinder pressure is controlled not by a pump but by an electric motor. Accordingly, required quietness can be ensured.
(18) The brake apparatus as set forth in the above (15) may include a step S1 (brake operating part operating quantity calculating section (displacement, angle)) of calculating an operating quantity of the parking brake switch 45; a step S2 (target braking force command value calculating section) of calculating a command value of target braking force in accordance with the calculated brake operating part operating quantity; and a step S5 (upstream and downstream target braking force command value calculating section) of distributing the calculated command value of target braking force into a braking force command value (upstream target braking force command value) for activating activate the E-ACT 60 and a braking force command value (downstream target braking force command value) for activating the ESC 31, which is larger than the upstream target braking force command value; wherein the E-ACT controller 35 selectively or simultaneously activates at least one of the E-ACT 60 and the ESC 31 in accordance with the calculated operating quantity of the brake operating part and the magnitude of each of the upstream and downstream target braking force command values. Accordingly, it is possible to reduce the frequency of activation of the E-ACT 60 and also possible to reduce the activation frequency of the ESC 31. Thus, operating noise can be reduced. It should be noted that, in the first embodiment, the operating time of the parking brake switch 45 is used as the brake operating part operating quantity. However, the brake operating part operating quantity is not particularly limited to the operating time of the parking brake switch 45. For example, the brake operating part operating quantity may be determined by the operating quantity (actuating quantity) or operating position (actuating angle) of the parking brake switch 45.
(19) The brake apparatus as set forth in the above (15) may include a step S2 (vehicle body speed calculating section) of calculating a quasi-vehicle body speed which is a speed of a vehicle body, wherein the E-ACT controller 35 selects at least one of the E-ACT 60 and the ESC 31 to be activated in accordance with the calculated vehicle body speed. In other words, when the vehicle body speed is in a low speed region in which quietness is required, the E-ACT 60 is activated to generate a fluid pressure quietly, whereas, when the vehicle body speed is in a high speed region in which operating noise is not offensive to the driver, the pump of the ESC 31 is activated to generate a fluid pressure, thereby achieving a reduction in operating noise and, at the same time, allowing a reduction in the frequency of activation of each actuator.
(20) A method of controlling a brake system, the brake system including: an E-ACT 60 (upstream brake fluid pressure generating device) automatically generating a fluid pressure in a master cylinder M/C that generates a fluid pressure in response to an operation of a brake pedal BP by a driver to control a wheel cylinder fluid pressure in a wheel cylinder provided for a wheel; an ESC 31 (downstream brake fluid pressure generating device) driving a pump and a control valve to variably control the wheel cylinder fluid pressure with a brake fluid sucked in from the master cylinder M/C by the pump; and a parking brake switch 45 (brake operating part) provided separately from the brake pedal BP so as to be operated by the driver to apply braking force to the wheel; wherein, when the parking brake switch 45 is operated, at least one of the E-ACT 60 and the ESC 31 is activated to control the wheel cylinder fluid pressure. Accordingly, it is possible to realize cooperative control by a plurality of actuators capable of generating braking force based on an operation of the parking brake switch 45 and hence possible to reduce the frequency of activation of each fluid pressure generating device. It should be noted that the activation frequency can also be reduced by an arrangement wherein an E-PKB 50 is assumed to be or used as the downstream brake fluid pressure generating device and activated after the vehicle has stopped. Further, at least one of the E-ACT 60 and the ESC 31 may be activated based on an operation of not only the parking brake switch 45 but also a device (brake lever or the like) capable of sensing a driver's braking intention other than the brake pedal.

Thus, according to the above-described embodiments, cooperatively controlling the upstream brake fluid pressure generating device and the downstream brake fluid pressure generating device makes it possible to reduce the frequency of activation of each fluid pressure generating device and to achieve a noise reduction at low cost.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2013-184371 filed on Sep. 5, 2013. The entire disclosure of Japanese Patent Application No. 2013-filed on Sep. 5, 2013 including specification, claims, drawings and summary is incorporated herein by reference in its entirety.

The entire disclosure of Japanese Patent Application Publication No. 2000-203410 including specification, claims, drawings and summary is incorporated herein by reference in its entirety.

What is claimed is:

1. A brake system comprising:
a master cylinder generating a fluid pressure in response to an operation of a brake pedal by a driver;
an upstream brake fluid pressure generating device automatically generating a fluid pressure in the master cylinder to control a wheel cylinder fluid pressure in a wheel cylinder provided for a wheel;
a downstream brake fluid pressure generating device driving a pump and a control valve to variably control the wheel cylinder fluid pressure with a brake fluid sucked in from the master cylinder by the pump;
a brake operating part provided separately from the brake pedal, the brake operating part being operable by the driver to apply braking force to the wheel; and
a wheel cylinder fluid pressure cooperative control unit controlling the wheel cylinder fluid pressure by activating at least one of the upstream brake fluid pressure generating device and the downstream brake fluid pressure generating device in response to an operation of the brake operating part.

2. The brake system of claim 1, further comprising:
a brake operating part operating quantity calculating section calculating an operating quantity of the brake operating part;
a target braking force command value calculating section calculating a command value of target braking force in accordance with the calculated operating quantity of the brake operating part; and
an upstream and downstream target braking force command value calculating section distributing the calculated command value of target braking force into an upstream target braking force command value for activating the upstream brake fluid pressure generating device and a downstream target braking force command value for activating the downstream brake fluid pressure generating device, the downstream target braking force command value being larger than the upstream target braking force command value;
wherein the wheel cylinder fluid pressure cooperative control unit activates at least one of the upstream brake fluid pressure generating device and the downstream brake fluid pressure generating device in one of selective and simultaneous manners in accordance with the operating quantity of the brake operating part calculated by the brake operating part operating quantity calculating section and a magnitude of each of the calculated braking force command values.

3. The brake system of claim 2, further comprising:
an upstream and downstream target braking force command value correcting section correcting the upstream target braking force command value calculated by the upstream and downstream target braking force command value calculating section, which is a command value of braking force to be generated by the upstream brake fluid pressure generating device, and correcting the downstream target braking force command value calculated by the upstream and downstream target braking force command value calculating section, which is a command value of braking force to be generated by the downstream brake fluid pressure generating device;
wherein, when distribution of the command value of braking force calculated in accordance with one of operating time and operating quantity of the brake operating part is changed in accordance with a vehicle body speed, the upstream and downstream target braking force command value correcting section proportionally changes the distribution of the command value of braking force to each of the brake fluid pressure generating devices when the vehicle body speed is between a first preset vehicle body speed and a second preset vehicle body speed other than the first preset vehicle body speed.

4. The brake system of claim 1, further comprising:
a vehicle body speed calculating section calculating a quasi-vehicle body speed which is a speed of a vehicle body;
wherein the wheel cylinder fluid pressure cooperative control unit selects at least one of the upstream brake fluid pressure generating device and the downstream brake fluid pressure generating device to be activated in accordance with the calculated vehicle body speed.

5. The brake system of claim 1, further comprising:
a brake operating part operating quantity calculating section calculating an operating quantity of the brake operating part;
a target braking force command value calculating section calculating a command value of target braking force in accordance with the calculated brake operating part operating quantity;
an upstream and downstream target braking force command value calculating section distributing the calculated command value of target braking force into an upstream target braking force command value for activating the upstream brake fluid pressure generating device and a downstream target braking force command value for activating the downstream brake fluid pressure generating device, the downstream target braking force command value being larger than the upstream target braking force command value; and
a lateral acceleration calculating section calculating lateral acceleration acting on a vehicle;
wherein an upper limit value of the calculated upstream target braking force command value is changed in accordance with a magnitude of the calculated lateral acceleration.

6. The brake system of claim 5, wherein an upper limit value of the calculated upstream target braking force command value is changed in accordance with a magnitude of the calculated lateral acceleration, and distribution of the braking force command value to each of the brake fluid pressure generating devices is proportionally changed when the calculated lateral acceleration is between a first preset value of lateral acceleration and a second preset value of lateral acceleration other than the first preset value of lateral acceleration.

7. The brake system of claim 1, further comprising:
a brake operating part operating quantity calculating section calculating an operating quantity of the brake operating part; and
a target braking force command value calculating section calculating a command value of target braking force in accordance with the calculated brake operating part operating quantity;
wherein the brake operating part is a parking switch switchable by the driver; and
when the parking switch is turned from ON to OFF, the target braking force command value is gradually reduced so that the fluid pressure reaches zero after a predetermined time has elapsed.

8. The brake system of claim 5, wherein the brake operating part is a parking lever actuatable by a driver's pulling operation, and the target braking force command value calculating section reduces the command value of target braking force in accordance with an operating quantity of the parking lever.

9. The brake system of claim 1, further comprising:
an accelerator pedal operation state calculating section calculating a driver's accelerator pedal operation state;
wherein, when an accelerator pedal depressing state is calculated by the accelerator pedal operation state calculating section, the target braking force command value is increased by adding thereto braking force for canceling torque estimated to be generated by depression of the accelerator pedal.

10. The brake system of claim 1, wherein a stop light provided on the vehicle is turned on, when a braking operation is started with the brake operating part and resulting deceleration is not less than a predetermined deceleration value.

11. The brake system of claim 1, further comprising:
a driving force reduction control section reducing driving force of a drive source mounted on a vehicle when a braking operation is started with the brake operating part.

12. The brake system of claim 11, wherein the driving force reduction control section reduces the driving force to a level not higher than braking force generated by activating at least one of the upstream brake fluid pressure generating device and the downstream brake fluid pressure generating device.

13. The brake system of claim 1, wherein, when a braking operation is started with the brake operating part, a gear ratio of a transmission mounted on a vehicle is switched to a low-speed side.

14. The brake system of claim 1, further comprising:
a regenerative brake device;
wherein the regenerative brake device is activated when a braking operation is started with the brake operating part.

15. A brake apparatus comprising:
an upstream brake fluid pressure generating device automatically generating a fluid pressure in a master cylinder that generates a fluid pressure in response to an operation of a brake pedal by a driver to control a wheel cylinder fluid pressure in a wheel cylinder provided for a wheel;
a downstream brake fluid pressure generating device driving a pump and a control valve to variably control the wheel cylinder fluid pressure with a brake fluid sucked in from the master cylinder by the pump; and
a wheel cylinder fluid pressure cooperative control unit controlling the wheel cylinder fluid pressure by activating at least one of the upstream brake fluid pressure generating device and the downstream brake fluid pressure generating device in response to an operation of a brake operating part provided separately from the brake pedal, the brake operating part being operable by the driver to apply braking force to the wheel.

16. The brake apparatus of claim 15, wherein the master cylinder includes a piston;
the upstream brake fluid pressure generating device has an upstream actuator driving the master cylinder to cause an axial movement of the piston; and
the downstream brake fluid pressure generating device has a plunger pump.

17. The brake apparatus of claim 16, wherein the upstream actuator is an electric motor.

18. The brake apparatus of claim 15, further comprising:
a brake operating part operating quantity calculating section calculating an operating quantity of the brake operating part;
a target braking force command value calculating section calculating a command value of target braking force in accordance with the calculated operating quantity of the brake operating part; and
an upstream and downstream target braking force command value calculating section distributing the calculated command value of target braking force into an upstream target braking force command value for activating the upstream brake fluid pressure generating device and a downstream target braking force command value for activating the downstream brake fluid pressure generating device, the downstream target braking force command value being larger than the upstream target braking force command value;
wherein the wheel cylinder fluid pressure cooperative control unit activates at least one of the upstream brake fluid pressure generating device and the downstream brake fluid pressure generating device in one of selective and simultaneous manners in accordance with the calculated operating quantity of the brake operating part and a magnitude of each of the upstream and downstream target braking force command values.

19. The brake apparatus of claim 15, further comprising:
a vehicle body speed calculating section calculating a speed of a vehicle body;
wherein the wheel cylinder fluid pressure cooperative control unit selects at least one of the upstream brake fluid pressure generating device and the downstream brake fluid pressure generating device to be activated in accordance with the calculated speed of the vehicle body.

20. A method of controlling a brake system, the brake system comprising:
an upstream brake fluid pressure generating device automatically generating a fluid pressure in a master cylinder that generates a fluid pressure in response to an operation of
a brake pedal by a driver to control a wheel cylinder fluid pressure in a wheel cylinder provided for a wheel;
a downstream brake fluid pressure generating device driving a pump and a control valve to variably control the wheel cylinder fluid pressure with a brake fluid sucked in from the master cylinder by the pump; and
a brake operating part provided separately from the brake pedal, the brake operating part being operable by the driver to apply braking force to the wheel;
the method including:
controlling the wheel cylinder fluid pressure by activating at least one of the upstream brake fluid pressure generating device and the downstream brake fluid pressure generating device, when the brake operating part is operated.
